(19) United States
(12) Patent Application Publication
(10) Pub. No.: US 2007/0103934 A1
(43) Pub. Date: May 10, 2007

(54) System and method for constructing a backlighted display using dynamically optimized light source

(76) Inventors: Kean Loo Keh, Penang (MY); Kevin Len Li Lim, Perak (MY); Joon Chok Lee, Sarawak (MY); Eit Thian Yap, Penang (MY); Chin Hin Oon, Penang (MY)

Correspondence Address: AVAGO TECHNOLOGIES, LTD., P.O. BOX 1920, DENVER, CO, 80201-1920, US

(21) Appl. No.: 11/271,186

(22) Filed: Nov. 10, 2005

(51) Int. Cl. F21V 7/04

(52) U.S. Cl. 362/612; 362/613; 362/608

(57) ABSTRACT

A combination of light source types is used to form a dynamically adjusted backlighted display with the particular combination dependant upon the desired light output at a given point in time. In one embodiment, RGB diodes are used for low brightness situations and as the brightness requirement increases white light sources are added. In another embodiment, different light source types are used to produce the different color components and optical feedback is used to control the power levels of the various diode types.

### TECHNICAL FIELD

This invention relates to backlighted displays and more particularly to light sources that are dynamically adjustable to achieve a desired output brightness.

### BACKGROUND OF THE INVENTION

It has become common to use backlighted displays for a variety of purposes. One such usage is in cellular phones, PDAs, cameras and other handheld devices. In many of these applications it is desired to have white back light and thus such displays typically use white (phosphor converted) light emitting diodes (LEDs) or cold crystal fluorescent lamps (CCFL) in conjunction with a liquid crystal display (LCD) to form the backlighted device.

Because a wider color gamut is often required than is available with CCFL or white LEDs, backlighted devices are beginning to use red, green and blue (RGB) LEDs. The light output of these red, green and blue LEDs are mixed to produce the required color. However, because their light output (primarily the green LED) is not as efficient in lumens/watt as CCFLs or white diodes more RGB diodes are required. In some situations, red diodes are used in combination with other green and blue light sources, such as CCFLs, to produce white light.

### BRIEF SUMMARY OF THE INVENTION

A combination of light source types is used to form a dynamically adjusted backlighted display with the particular combination dependant upon the desired light output at a given point in time. In one embodiment, RGB diodes are used for low brightness situations and as the brightness requirement increases white light sources are added. In another embodiment, different light source types are used to produce the different color components and optical feedback is used to control the power levels of the various diode types.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a backlighted display;

FIG. 2 shows one embodiment of a backlighted display using feedback for color control; and

FIGS. 3A, 3B, and 3C are charts showing the composite light from different light types.

### DETAILED DESCRIPTION OF THE INVENTION

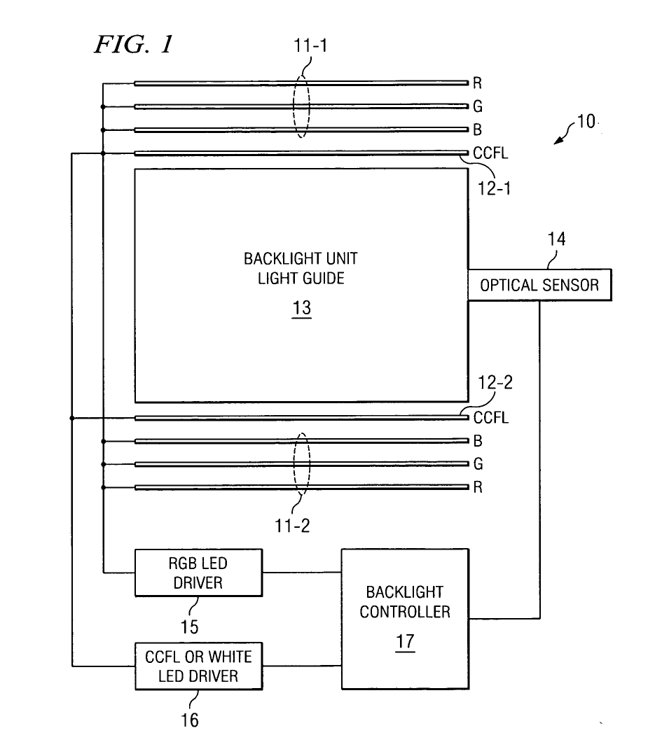

FIG. 1 shows one embodiment of backlighted display 10 having light guide 13 and having two independently controllable light sources 111 and 12. In this embodiment, light source 11 (11-1, 11-2) is one or more RGB LED arrays and light source 12 (12-1, 12-2) is a CCFL or white LED source. Note that the white light source can be a single diode array or could be a plurality of red, green, blue (or other colors) CCFLs or phosphor covered LEDs biased to achieve white light.

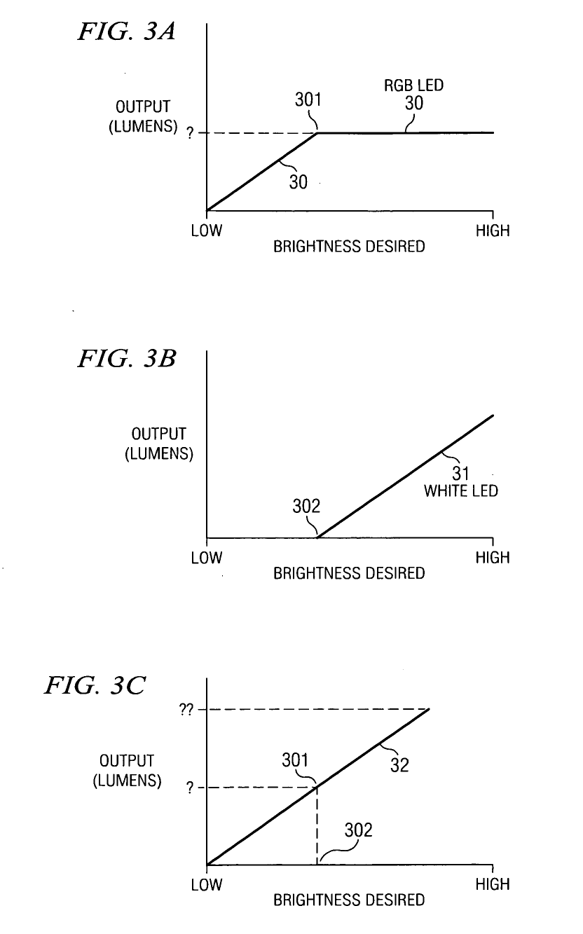

Optical sensor 14 can determine both the color of the light and the intensity of the light. In this embodiment the intensity is important such that backlight controller 17 will use readings from sensor 14 to increase RGB LED driver 15 until a point is reached where further power to RGB LED driver 15 will not increase the lumen output. As shown in FIG. 3A, line 30 represents the increase in lumen output of RGB LED until point 301. When point 301 is reached, the lumen output goes essentially flat.

At that point backlight controller 17 (FIG. 1) begins to increase the lumen output of the white light source under control of driver 16. As shown in FIG. 3B, point 302 is the point at which the backlight controller begins to have CCFL (or white light) driver 16 turn on. Line 31 shows the white light increase from elements 12-1, 12-2. FIG. 3C shows the composite from FIGS. 3A and 3B where the light output, which is measured by optical sensor 14, is shown as line 32.

In one embodiment, the optical sensor can be implemented by letting the RGB LEDs go on open loop when the white LED is turned on, since the addition of white will interfere with the RGB LED backlight. The sensor could then be turned off. Color point measurement is performed only at the beginning. For example, the system would turn on RGB LEDs and bring the backlight to the desired color level. Then the RGB LEDs would go on open loop (turned off) while the while LEDSs remain on. Alternatively, the system could selectively blank the white LEDs for a brief moment. During that brief moment, any intensity correction can be made. For example, the RGB LEDs are turned on and the backlight is brought to the desired color point. Then put the RFB LEDS on open loop and turn on the white LEDs. Then turn off the white LEDs and put the RGB LEDs back on closed LEDs loop for a very brief period. Then put RGB LEDs back on open loop and turn on white LEDs. Another system would be to assume that the sensor has a standard CIE output or a sensor that can be calibrated to the CIE standard (human eye response). In this case, RGB+white LEDs can be turned on at the same time and the feedback system can maintain the color point and brightness in a closed loop.

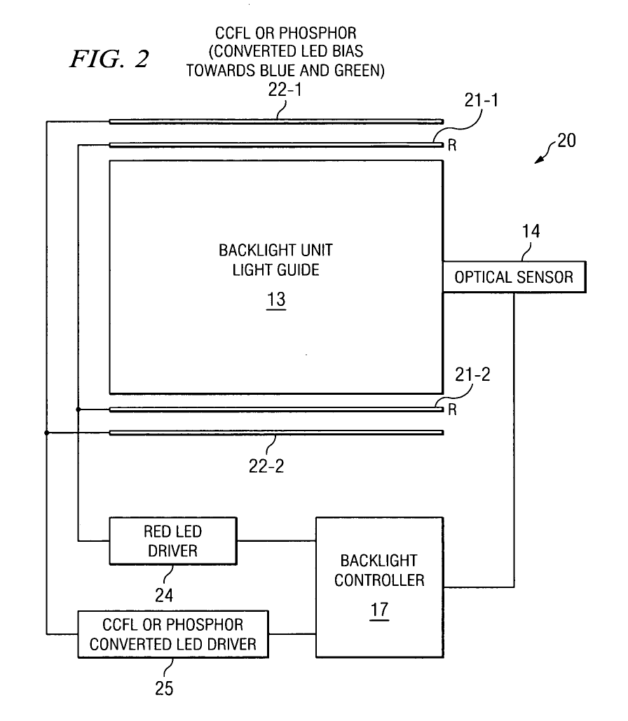

FIG. 2 shows one embodiment of device 20 where the two different light sources are RED LED 21-1, 21-2 and CCFL or phosphor converted LED (or CCFL) 22-1, 22-2. If phosphor converted LEDs are used then the output would be biased towards blue and green which would then match with the red from light source 21-1, 21-2 to provide essentially white light through light guide 13 of backlighted device 20. In this embodiment, optical sensor 14 detects the relative color and intensity and acts as an input to backlight controller 17 which in turn drives RED LED driver 24 to provide LIGHT in the red spectrum and CCFL or phosphor converted LED driver 25 to provide the remainder of the color balance. In this way the output through light guide 13 comprises light from two different source types, namely 21-1, 21-2, 22-1, and 22-2.

Using this technique, device 20 provides high efficiency in terms of lumens per watt for a wide color gamut while also compensating for color drift and degradation over time.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A back-light display comprising:
a first light source having a first light emitting characteristic:
a second light source having a second light emitting characteristic, and
a control circuit for adjusting one of said light sources relative to the other of said light sources dependant upon the output brightness desired of said display at any point in time.

2. The display of claim 1 wherein said display is a LCD display.

3. The display of claim 1 wherein said first light source is a first LED type and said second light source is a second LED type.

4. The display of claim 3 wherein said first LED type are white diodes and said second LED type are RGB LEDs.

5. The display of claim 1 wherein said first light source are RGB LEDs and said second light source is selected from the list of: CCFL, phosphor converted LEDs.

6. The display of claim 5 wherein said control circuit is further operable for enabling only said first LEDs when low brightness light outputs are required and for enabling both said first and said second LEDs when increased brightness output is required.

7. The display of claim 6 wherein said control circuit is further operable for gradually increasing the light output from said second LEDs as the brightness requirement increases from said low level to a maximum level.

8. The display of claim 1 wherein said first light source is a light device having less than all the colors red, green and blue as its light output and said second light source is a light device having at least the remaining colors from said red, green and blue as its light output.

9. The display of claim 8 wherein said control circuit is further operable for adjusting the color output of said first light source to achieve at least one criterion selected from the list of: desired output color, desired output brightness level.

10. The display of claim 8 wherein said first light source is a red LED and wherein said second light source has a light output of green and blue.

11. The device of claim 10 wherein said second light source is biased toward blue and green, said second source selected from the list of CCFL, phosphor converted LED.

12. The method of constructing a backlighted display, said method comprising:
positioning a first light source having a first light emitting characteristic so that light coming from said first light source impacts a liquid crystal display; (LCD);
positioning a second light source having a second light emitting characteristic so that light coming from said second light source mixes with said light coming from said first light source so as to control the color and intensity of the light impacting said LCD; and
connecting at least one of said first or second light sources in a manner to be controlled independently depending upon the output brightness desired from said LCD.

13. The method of claim 12 wherein said first light source is a first LED type and said second light source is a second LED type.

14. The method of claim 13 wherein said first LED type is a white diode and said second LED type is a RGB LED.

15. The method of claim 12 wherein said first light source is a RGB LED and said second light source is selected from the list of: CCFL, phosphor converted LED.

16. The method of claim 12 wherein said first light source is a light device having less than all the colors red, green and blue as its light output and said second light source is a light device having at least the remaining colors from said red, green and blue as its light output.

17. The method of claim 16 further comprising:
adjusting the color output of said first light source to achieve at least one criterion selected from the list of: desired output color, desired output brightness level.

18. A LCD backlighted display comprising:
a first light source having a first light emitting characteristic;
a second light source having a second light emitting characteristic, and means for adjusting one of said light sources relative to the other of said light sources dependant upon the output light intensity desired of said display.

19. The display of claim 18 wherein said first light source is a first LED type and said second light source is a second LED type.

20. The display of claim 18 wherein said first LED type is a diode emitting an essentially white light and said second LED type is a RGB LED.

21. The display of claim 18 wherein said first light source is a RGB LED and said second light source is selected from the list of: CCFL, phosphor converted LED.

22. The display of claim 18 wherein said light intensity comprises a derived light color.
